(19) United States
(12) Patent Application Publication
(10) Pub. No.: US 2015/0006232 A1
(43) Pub. Date: Jan. 1, 2015

(54) ADAPTIVE PROJECT PLANNING

(71) Applicant: International Business Machines Corporation, Armonk, NY (US)

(72) Inventors: Ateret Anaby-Tavor, Givat Ada (IL); Ashraf Haib, Rama (IL); Elad Fein, Osafia (IL); Moran Gavish, Kibbutz Ein Carmel (IL); Lior Limonad, Nesher (IL)

(21) Appl. No.: 13/932,026

(22) Filed: Jul. 1, 2013

(51) Int. Cl. G06Q 10/06

(52) U.S. Cl. CPC G06Q 10/06316
USPC 705/7.26

(57) ABSTRACT

A system for project planning comprising: a processor; a graphical user interface which: receives a project plan having a plurality of project tasks hierarchically arranged in a plurality of tiers, associated by a plurality of parent-child relationships; enables a user to provide a plurality of project task characteristics for at least one of said plurality of project tasks; enables a user to alter a first at least one of a plurality of project task characteristics of a first project task; and a propagation software engine for adapting a second at least one of a plurality of project task characteristics of a second project task wherein a tier of said second project task is lower in a hierarchy arrangement with respect to a tier of first project task, using said processor.

### BACKGROUND

The present invention, in some embodiments thereof, relates to methods, computer programs and/or systems for project planning and, more specifically, but not exclusively, to methods, computer programs and/or systems for adapting project tasks in a hierarchical arrangement and/or their related project tasks characteristics as implied from a plurality of specified constraining rules. As used herein, the phrase project panning means a sub field of project management related to scheduling, estimating progress, reporting progress, generating and/or applying logical dependencies between tasks, allocating resources, calculating and/or estimating costs Scheduling may be, for example, a form of Gantt charts. Applying logical dependencies may be, for example, identifying a critical path in a project. Project planning may comply with project objectives by balancing between two of the above mentioned activities such as, for example, resource usage and project duration.

Projects in a diverse variety of areas such as manufacturing, transportation, logistics, financial services, utilities, energy, telecommunications, government, aviation, information technology (IT), defense, and retail are managed in similar manners. Project management typically includes endeavors such as: scheduling, human resources management, inventory resource management, finance, risk management, and communications. Each endeavor typically involves multiple activities which may relate to one another and depend on one another. Effectively managing such activities is often associated with shorter execution periods, higher predictability, increased resource utilization efficiency and reduced costs. Software tools, communication tools and visual aids for project management aim to increase such efficiency. Project management using tools and visual aids date back to the 1910s, when Henry Gantt, an American mechanical engineer, developed the so called Gantt-chart—a graphic representation of a project schedule showing activities as bars of a length proportional to activity's time duration. Modern project management tools typically offer features such as multiple user logins (typically with different granted data access privileges), tags and categories (for example: “Started”, “In Progress”, “Complete”, “In Planning”, “Proposed”, “Postponed”, “On Hold”, “Archived” and “Undefined”). File sharing in the form of a centralized repository or as attachments, Discussion forums, Automatic electronic mail notifications, Progress track, for example by using graphical Gantt charts, Dependant Project Activities: utilizing a hierarchical activity list and Contact List including virtual business cards of clients, vendors and employees.

### SUMMARY

According to an aspect of some embodiments of the present invention there is provided a computerized method for project planning, comprising: receiving a project plan having a plurality of project tasks hierarchically arranged in a plurality of tiers forming a plurality of parent-child relationships and associated by a plurality of constraining relationships defined between members of two or more of said plurality of project tasks; receiving an alteration to at least one altered project task characteristic of a plurality of project task characteristics of an altered project task; adapting at least one child project task characteristic of a child project task according to said at least one altered project task characteristic in compliance with at least one a plurality of constraining relationships defined between said altered project task and said child project task; and adapting at least one parent project task characteristic of a parent project task according to said at least one altered project task characteristic in compliance with at least one a plurality of constraining relationships defined between said altered project task and said parent project task; wherein said child project task is a child of said altered project task and said parent project task is a parent of said altered project task.

Optionally, said adapting occurs prior to receiving a request from a user to do at least one of display, read, copy, modify and delete said at least one of a plurality of project task characteristics of a second project task. Optionally, the further comprises: indicating a change of at least one of said third project task and said third at least one of a plurality of project task characteristics. Optionally, said plurality of project task characteristics is scheduling data, provided as at least one of a start date, an end date, a duration period, an amount of working hours, an amount of working days and a relative part of a duration period. Optionally, said plurality of project task characteristics comprises at least one of a budget amount, a relative part of a budget, facility usage and resource consumption. Optionally, said altering is performed by at least one of modifying said plurality of a first at least one of a plurality of project task characteristics and adding an additional at least one of a plurality of project task characteristics. Optionally, the method further comprises: receiving an additional plurality of project tasks having an additional plurality of project task characteristics; associating said additional plurality of project tasks to at least one of said plurality of project tasks by establishing at least one parent-child relationship; adapting at least one of said plurality of project task characteristics according to said additional plurality of project task characteristics. Optionally, each said plurality of project tasks is at least one of an integrating a software, integrating an instrument, producing a part, designing a part, up-scale a pipeline, quality assurance testing and a project planning task. Adapting is automatically performed. Optionally, said at least one relative term (a type of a constraining rule also known as a “mutual invariant”) is at least one of a percentile, a portion, a multiplication factor, an equality, a range of a plurality of percentiles, a range of a plurality of portions and a range of a plurality of multiplication factors. Optionally, said adapting is performed independently of a user's usage of said plurality of project tasks. Optionally, said plurality of project task characteristics is defined by at least one relative term (an invariant). Optionally, said plurality of project task characteristics is defined by at least one absolute term (a type of a constraining rule also known as a “local invariant”). Optionally, said at least one absolute term is at least one of a maximal numerical limit, a minimal numerical limit, a maximal date and a minimal date. Optionally, said plurality of tiers is provided by a tree structure. Optionally, said plurality of project tasks relate to one another by at least one of a predecessor relationship (a type of a constraining rule also known as a “mutual invariant”), a successor relationship and a parallel occurrence relationship (a type of a constraining rule also known as a “mutual invariant”); and wherein said adapting is performed according to a plurality of constraining relations between said plurality of project tasks. Optionally, the method further comprises: defining a plurality of adaptation strategies. Optionally, each of said plurality of adaptation strategies is at least one of: show inconsistency, resolve inconsistency, and propagate over a subset of said plurality of tiers.

According to an aspect of some embodiments of the present invention there is provided a computerized method for project planning, comprising: a computer readable storage medium; first program instructions to receive a project plan having a plurality of project tasks hierarchically arranged in a plurality of tiers, associated by a plurality of parent-child relationships; second program instructions to provide a plurality of project task constraining rules for at least one of said plurality of project tasks; third program instructions to receive an alteration to a first at least one of a plurality of project task characteristics of a first project task; and fourth program instructions to adapt a second at least one of a plurality of project task characteristics of a second project task wherein a tier of said second project task is lower in a hierarchy arrangement with respect to a tier of first project task; wherein said first, second, third and fourth program instructions are implied from the given plurality of task constraining rules and being stored on said computer readable storage medium.

According to an aspect of some embodiments of the present invention there is provided a system for project planning comprising: a processor; a graphical user interface which: receives a project plan having a plurality of project tasks hierarchically arranged in a plurality of tiers, associated by a plurality of parent-child relationships; enables a user to provide a plurality of project task constraining rules for at least one of said plurality of project tasks; enables a user to alter a first at least one of a plurality of project task characteristics of a first project task; and a propagation software engine for adapting a second at least one of a plurality of project task characteristics of a second project task wherein a tier of said second project task is lower in a hierarchy arrangement with respect to a tier of first project task, using said processor.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is an illustration of a computerized method for project planning, according to some embodiments of the present invention;

FIG. 2 is an illustration of a system for project planning, according to some embodiments of the present invention.

FIG. 3 is an illustration of a project plan with relative start and duration characteristics, according to some embodiments of the present invention;

FIG. 4 is an illustration of a project plan with multi-tiers project tasks, according to some embodiments of the present invention;

FIG. 5 is an illustration of a fragment of a project plan Gantt chart, according to some embodiments of the present invention; and

FIG. 6 is an illustration of a fragment of a modified project plan Gantt chart, according to some embodiments of the present invention.

### DETAILED DESCRIPTION

The present invention, in some embodiments thereof, relates to methods, computer programs and/or systems for project planning and, more specifically, but not exclusively, to methods, computer programs and/or systems for adapting project tasks in a hierarchical arrangement and/or their related project tasks characteristics as implied from a plurality of specified constraining rules.

A project plan comprises: multiple tasks organized in tiers forming a hierarchy, and a plurality of additional inter-task constraining rules, also referred to as invariants, which determine various characteristic correspondences to be maintained between their corresponding task characteristics. Each task is characterized by multiple project task characteristics. Such a project setup allows a single point of alteration to a project task and/or its characteristic(s). That alteration is then propagated to at least one other task and/or task characteristics. The alteration is propagated throughout the hierarchy of the project. Optionally, the propagation is performed in both directions simultaneously: bottom-up and top-down. Optionally, the propagation is performed in one direction through the tasks' hierarchy, for example top-down then followed by an adaptation of tasks in the other direction, in this case bottom-up. Optionally, multiple passes over the hierarchy occur in one direction then occur in the other direction in order to comply with the constraints of tasks.

A project setup, as described above: having multiple hierarchical tasks with multiple constraints between tasks, allows a partial specification of tasks, as well as their characteristics, for example planning tasks representing an overview of higher tiers before filling in all the tasks of lower more specific tiers. In such an example, once the project planning mature more specific tasks are introduced. The characteristics of higher tiers are then automatically propagated into newly introduced tasks and their characteristics. In a similar manner, revision of tasks and their characteristics is propagated, enabling managers to make changes at a single point regardless of the task's tier.

In early stages of planning a project, it is most natural for project managers to plan and to schedule tasks and activities using a top-down approach. By setting dates and durations for the top level phases first, then refine the project plan with the lower level break-down structure. According to some embodiments of the present invention, a system comprising a propagation software engine enables a user to setup project tasks, relations between tasks, as well as project tasks characteristics for higher tiers first, then to alter and provide additional tasks, relations and characteristics at lower tiers. The propagation software engine automatically updates lower and/or higher level tasks and characteristics according to these additions and/or modifications.

A computerized method for project planning is disclosed herein, which enables top-down project planning A project plan is received. The project plan has constraining relationship. A constraining relationship may be associating two (or more) project tasks. A constraining relationship may be start time of a second project task which is later than the end time of a first project task, non parallel execution time, resource usage, budget and/or personal involved in execution and/or management. Non parallel execution time may be inferred from mutual usage of the same limited resource. For example: a first project task requires a certain machine for its execution and second project task requires that same machine for its execution. If only a single machine is available these tasks may be scheduled in non parallel times. Some and/or all of the constraining relationship are parent-child relationship, making the project plan a hierarchical project plan having tiers. The project plan's tasks have characteristics such as start time, duration, resource usage etc. Some of the characteristics are constrained by rules related also to other task characteristics. Altered tasks and their altered characteristics are propagated through the hierarchy. For example, altered tasks and their altered characteristics are propagated down the hierarchy by adapting lower level tasks and their characteristics. This method may provide alternative to the more traditional and prevalent bottom-up project planning methodologies. Applying bottom-up approach requires the project managers to start by defining the entire project task characteristics, then grouping them into logical clusters for creating task hierarchies. In a bottom-up approach, summary project tasks are accumulating characteristics of their children project task characteristics and their start date and duration are calculated by the software taking into account the full set of constraints and dependencies between their child tasks. Because the start and finish dates of a summary task are a result of calculation based on the characteristics of their child tasks, it is difficult to schedule a top level phase before the complete details of its subordinates are known. In addition, often project managers are given rigid time frame to execute a project phase. In this case they avoid from applying required changes to the beneath tasks, in order to eliminate the undesired effect on the summary task resulted by the automatic calculation.

According to some embodiments of the present invention, a user is able to expand, shrink, promote and/or delay the project task characteristics of entire project segments by a single change to a single level. The alteration, which may be applied to the topmost tier, is propagated from a single point to lower tiers by the propagation software engine. Optionally, the single change is performed as an alteration applied to a middle level task. The alteration then propagates through the hierarchy as described above. Optionally, inconsistencies created by the single change are resolved by propagating the change to upper tiers by the propagation software engine. Optionally, in case the propagation software engine propagates the change top-down, and not bottom-up, a confinement of the effect of an alteration is optionally achieved as higher tiers are not affected by the alteration.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

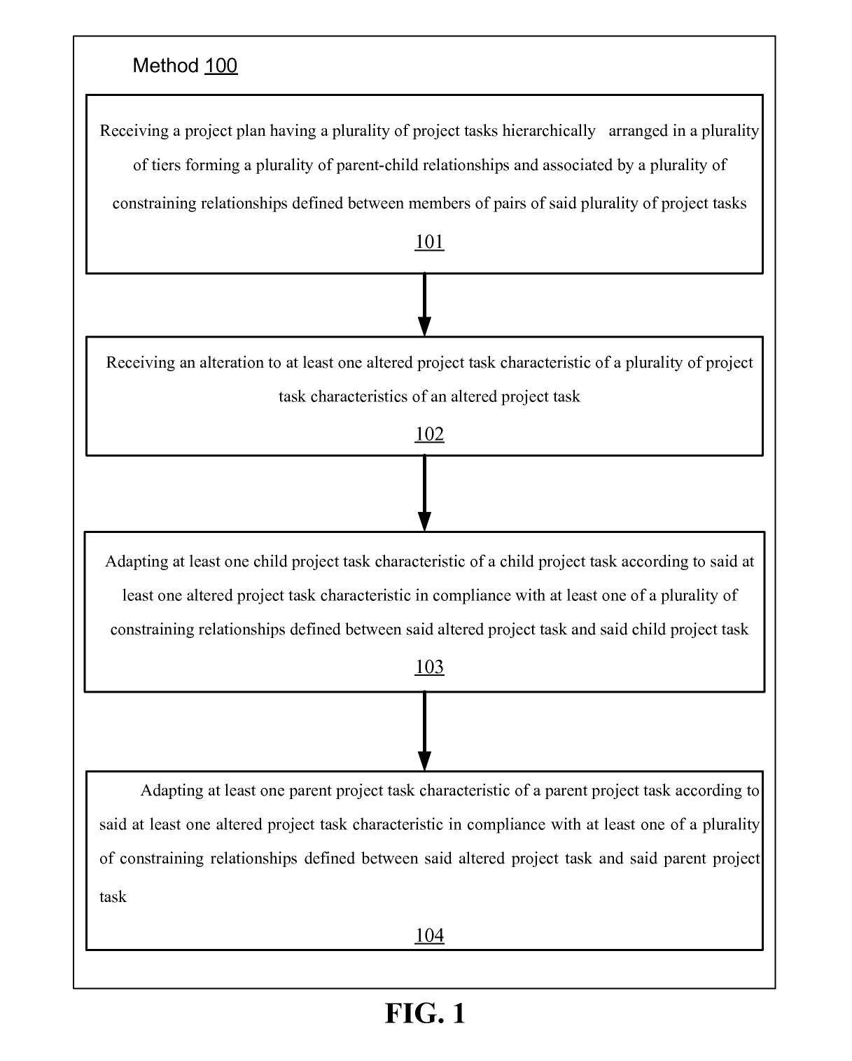

Reference is now made to FIG. 1 illustrating a computerized method 100 for project planning, according to some embodiments of the present invention. First a project plan is received 101. The project plan has project tasks. Project tasks may be, for example, integrating software, integrating an instrument, producing a part, designing a part, up-scale a pipeline, quality assurance testing, a project planning task etc. The project tasks are hierarchically arranged in a plurality of tiers forming a plurality of parent-child relationships. The project tasks are associated by constraining rules. Each constraining rule is defined between one project task and one or more other project tasks, thereby creating clusters of constrained project tasks. Constraining rules may be, for example, start one task only after the other task is 50% complete, finish task before start date of another task, schedule task once all needed resources are available etc. A parent-child relationship may be a direct connection between two project tasks in the hierarchy and/or may be an indirect relationship. The hierarchy describing the relations between project tasks may be considered as a mathematical graph such as a tree. The tree may represent a work breakdown structure (WBS). The project tasks are nodes in such a graph and relations between project tasks are edges in such a graph. An indirect parent-child relationship is a path in that graph which travels in a single direction along the tiers: from parents to children only or from children to parents only. Optionally, the tiers are provided by a tree structure. Optionally, project tasks are related to one another in other relationships (other than parent-child), such as, for example: overlapping project tasks within the same tier. Optionally, the hierarchical structure contains circles. An additional step is taken to resolve the circles, thereby converting the hierarchical structure into a tree structure. Then, an alteration is received for at least one project task characteristic 102. Project task characteristics may be constrained by one or more rules mutual also to other tasks such as a percentile, a portion, a multiplication factor, equality, a range of a plurality of percentiles, a range of a plurality of portions and/or a range of a plurality of multiplication factors of characteristics of other tasks. Project task characteristics may be constrained by one or more local rules such as: maximal numerical limit, a minimal numerical limit, a maximal date and/or a minimal date. Project task characteristics may be, for example, a budget amount, a relative part of a budget, facility usage, resource consumption etc. Altering may be modifying one (or more) project task characteristics. Altering may be adding a new additional project task characteristic. Adding another project task characteristic may be performed by receiving one (or more) project task having additional project task characteristics, associating the project task to one (or more) existing project task by establishing parent-child relationship(s), and adapting project task characteristics according to the additional project task characteristics. Then, at least one child project task characteristic of a child project task is adapted according to said at least one altered project task characteristic 103. The adaption is performed in compliance with at least one of a plurality of constraining rules defined between said altered project task and said child project task. Adapting may be changing, modifying, adding, subtracting and/or re-calculating an existing project task characteristic. Adapting may be adding a new project task characteristic which did not exist before adaptation. The child project task is a child of the altered project task. Then, at least one parent project task characteristic of a parent project task is adapted according to at least one of altered project task characteristic 104. The alteration is performed in compliance with at least one of a plurality of constraining rules defined between the altered project task and the parent project task. The parent project task is a parent of said altered project task. Optionally, the adapted project tasks are in turn treated as an alteration, thereby causing the alteration to propagate throughout the project in any direction according to the hierarchy and/or the constraining rules between project tasks and their project characteristics. Optionally, in case, no related project tasks exist—no action is taken. Adapting may be automatically performed, for example, upon detection of a project task characteristic alteration. Optionally, project task characteristics of other project tasks are adapted as well. Optionally, the tier of the other project tasks can be lower or higher with respect to the altered project task. Optionally, upon adapting higher tier project tasks inconsistencies between parent and child project task characteristics are created. Such inconsistency may be indicated, shown, displayed, resolved, and/or propagated. Optionally, the propagation occurs over a subset of a plurality of tiers. Optionally, adapting is performed independently of a user's usage of said plurality of project tasks. Adapting is performed regardless of the user demand for a specific project task and/or any of its characteristics.

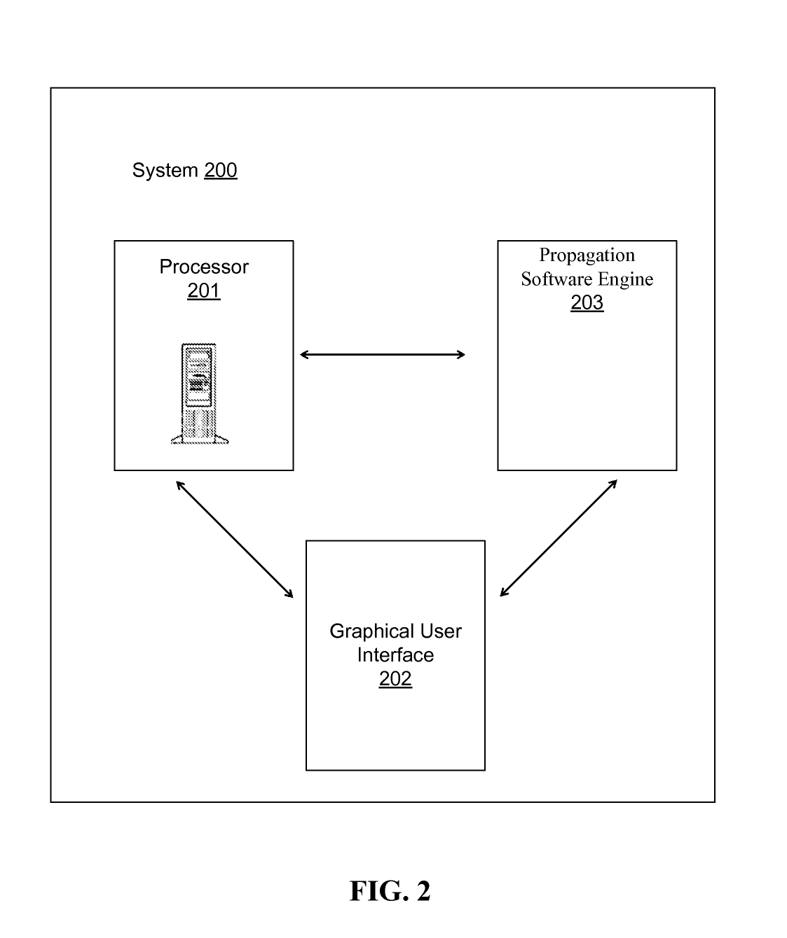

Reference is now made to FIG. 2 which illustrates a system 200 for project planning, according to some embodiments of the present invention. The system 600 comprises a processor 201, a graphical user interface 202 (GUI) and a propagation software engine 203. The GUI 202 receives a project plan. The project plan may be provided as a template and/or an instance. The project plan comprises multiple project tasks. The project tasks are hierarchically arranged in tiers. The project tasks are associated by parent-child relationships. The GUI 202 enables a user to provide project task characteristics for at least one project task. The GUI 202 further enables a user to alter one or more project task characteristics of some project task. A propagation software engine 203 adapts the characteristics of a project task according to the altered project task (and its characteristics). The adapted project task is of a lower tier in a hierarchy arrangement with respect to the altered project task. The adaptation is performed by the propagation software engine 203 using the processor 201. Optionally, the propagation software engine 203 also adapts the characteristics of a project task of a higher tier in a hierarchy arrangement. For example, a project has 3 tiers, marked A, B and C according to their hierarchy (from root to leaf in a tree structure). Task B is altered. Task C, which is lower in the hierarchy, is adapted accordingly. Task A, which is higher in the hierarchy, is adapted as well according to the alteration of tasks B and C.

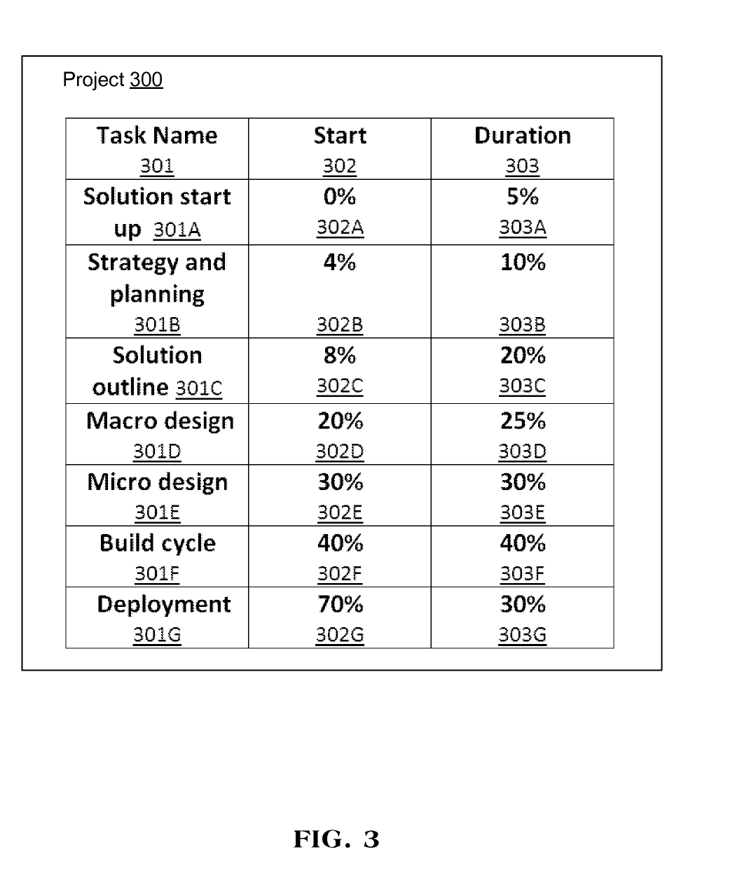

Reference is now made to FIG. 3 illustrating a project plan 300 with relative start 302 and duration 303 characteristics, according to some embodiments of the present invention. Such a project plan 300 may be generated by the system something new 200 illustrated in FIG. 2 and/or the method illustrated in FIG. 1. This exemplary project plan 300 comprises six project tasks 301A-301G. Each project task 301A-301G has two project task characteristics: start 302A-301G and duration 303A-303G respectively. The start 302 and duration 303 characteristics are provided in relative terms (as opposed to absolute term): percent of project duration. For example, the macro design task 301D starts when the project duration is 20% of its total duration and lasts for 25% of the project total duration (finished when the project is at 45% of its total duration). The project tasks characteristics 302A-302G and 303A-303G may be validated by various referential integrity constraints. In the case of task parameters being specifies proportional to their parent, the scheme should comply with [task.%_Start+task.%_Duration<=100%]. For example, if the duration of 303G would be bigger than 30% the start (70%) 302G and the duration would sum to more than a system for controlling infra red operated appliances 100%. Optionally, other validations methodologies are applied such as complying with maximal and/or minimal duration constraints, finish before an absolute calendar date and/or conform to a pool of available resource for multiple projects etc.

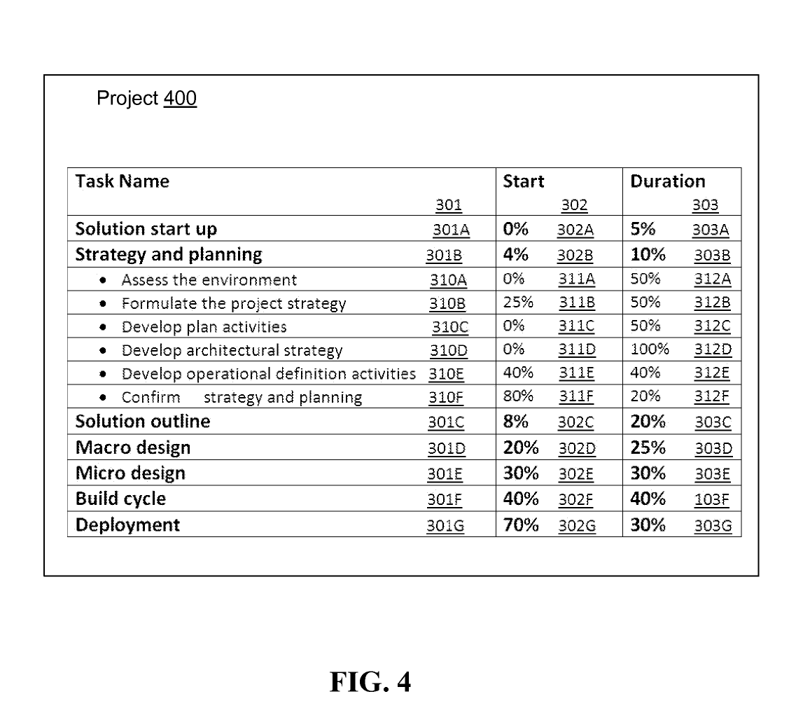

Reference is now made to FIG. 4 illustrating a project plan 400 with multi-tiers project tasks, according to some embodiments of the present invention. Such a project plan 400 may be generated by the system something new 200 illustrated in FIG. 2 and/or the method illustrated in FIG. 1. The project plan 400 is as described in FIG. 3. In this project plan 400, the strategy and planning task 301B has sub-tasks 110A-110F. The sub-tasks 110A-110F are children of project task 301B, and are lower in the project tasks hierarchy. In this example the start 302 and duration 303 project task characteristics of the lower tier project tasks 110A-110F are provided as percentile of the respective characteristics of the parent task 302B and 303B.

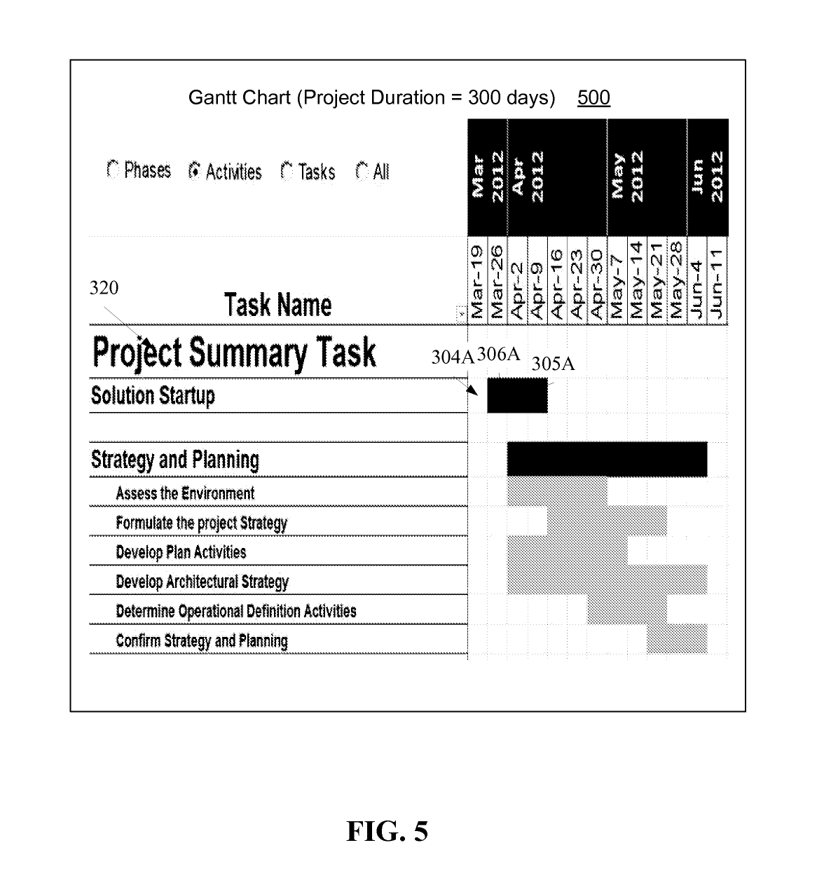

Reference is now made to FIG. 5 illustrating a fragment of a project plan Gantt chart 500, according to some embodiments of the present invention. The Gantt chart 300 illustrates the start date, end date and duration of some of the project tasks 301A, 301B, 110A-110F. The project plan 400 has a “Project Summary” 120 which is the root of the project tasks hierarchy. The “Project Summary Activity” 120 has project task characteristics: duration and start date. The entire project duration is set to 300 days and the start date is set to a 26^{th} of March (not illustrated). This alteration of a project task characteristic (addition of a start date and duration) is propagated down the hierarchy to child tasks 301A-301G and 110A-110F. For example, the start date 304A and the end date 305A and of the “Solution Startup” project task 301A, is set to 26^{th} March, 15^{th} April respectively. The bar displaying the task duration 306A of the “Solution Startup” project task is set accordingly. In a similar way the project task characteristics of the “Strategy and Planning” 301B task, which is a first tier task, are updated. After the characteristics of the “Solution Startup” task are set, the alteration propagates to the tasks of the next tier 310A-310F. The project characteristics of these tasks 311A-311F and 312A-312F are set according to characteristics of the parent task 302B, 302C.

Optionally, the propagation of project task characteristics is executed utilizing the algorithm described hereafter. This execution algorithm prescribes the propagation of various plan alterations that may be applied to any concrete project plan. It is a generic algorithm which may be used to account for any type of plan adjustments. This generic algorithm may be instantiated to accommodate for a more concrete conceptual modification the extension of a task (i.e., postpone in its end date). In its generic form, we consider the specification of a project plan template as follows:

### Where:

Task_{types}—is a set of process task names, each being associated with a set of attributes types A₁^{type} . . . Aᵢ^{type} (e.g., starttime, duraton).
Subtasks—is a function from Task_{types} to finite ordered subsets of Task_{types}, such that the relation
   R^{sub}={Task_{type}, Task_{type}|Task_{type}εSubstasks(Task_{type})} designates a complete process hierarchy. The root of this hierarchy is called the process' top-level task, and the leaves are called atomic tasks. A non-leaf node is called a parent node. For example:
{(car, wash, secure, wipers), (car, wash, external, wash), (car, wash, internal, clean), (internal, clean, vaccum, carpets), (internal, clean, rubber, spray) . . . }
   Constraints—is a set of two invariant types (i.e., a binary tuple):
   Local—is a function from Task_{types} to a set of execution invariants over the set of the corresponding task's attribute types.
      For example:

Local(car_{wash})→car_{wash}·duration=car_{wash}·endtime−car_{wash}·starttime

Mutual—is a function from R^{sub} to a finite set of execution invariants over attribute types in both Task_{types} and in Task_{type}, where

### (Task_{type}, Task_{type})εR^{sub}.

For example:

Mutual(car_{wash},secure_{wipers})→secure_{wipers}·starttime=car_{wash}·starttime+30% car_{wash}·duration

Implicitly, the set of mutual invariants also includes ones being automatically derived from the hierarchy—e.g.,

Mutual(car_{wash},internal_{clean})→car_{wash}·endtime≧internal_{clean}·endtime

Each project template T may be instantiated as a concrete project plan T¹ such that in the instantiation, all attribute types in T are associated with a specific value. The essence of “adaptiveness” in concrete project plans is in the realization of an algorithm that ensures preservation of all local and mutual invariants every time a concrete plan is being altered. We refer to such algorithm as a propagation algorithm. There may be various styles to the realization of such algorithm, each yielding a somewhat different behavior.

Specifically, a propagation algorithm prescribes how to accommodate for various concrete plan modifications, ensuring the preservation of true value to all execution invariants within the immediate surroundings of the node to which some modification has been applied, followed by the propagation of all implied changes to all of its parents and descendants. In its most generic form, the algorithm is specified as follows (the “\\” sign marks notes to the pseudo-code):

```
Apply(modify(task.attributes),T,T¹):
    Update - down(task) →
    Begin
    \\update task's parent and local attributes (if desired)
    M ← getMutualInvariants(task.parent,task)
    Foreach minv ε M,if false(minv),userchoice = “yes\”
        Begin
              \\notifies parent's task to re-compute its attributes
              Update - up(task.parent,minv)
              \\recompute task's self attributes
              L ← getLocalInvariants(task)
              Foreach linv ε L,if false(linv) →
                    linv.recompute(task.attributes,linv)
        End
    \\recursive call to all child nodes
    Foreach child ε task.childs →
        Update - down(child)
    End
    Update - up(task,inv) →
    Begin
        inv.recompute(task.attributes,inv)
        \\check if any of the remaining mutual invariants with any of its
        children are ‘broken’
        \\if yes, rewrite the invariant statement to match the new
        parent's attributes
        Foreach child ε task.childs →
              C ← getMutualInvariants(task.child)
              Foreach minv ε C, if false(minv) →
              minv.rewrite(task.attributes,minv)
        \\continue with change propagation to all parents when required
        M ← getMutualInvariants(task.parent,task)
        Foreach minv ε M,if false(minv) →
              Update - up(task.parent,minv)
    End
```

In its very core, the algorithm relies on two atomic operations: rewrite and re-compute (underlined), given a set of attributes as an input. In both cases, the input set is given to indicate the variables to be considered as bound to their current values within the context of the corresponding invariant expression. The former operation is used to rewrite the invariant's own expression (i.e., coefficient parameters) when all of its variables are bound. The latter operation is used to re-compute all free variables within the corresponding expression, considering the expression itself as fixed.

The following subsection demonstrates a concrete algorithm instantiations to demonstrate its operation in the context of task extension plan alteration.

For illustration purposes, we consider the following project plan ^{T}:
Tasks=[T1, T1.1,T1.2], each having three attribute types={starttime,endtime,duration},
Subtasks is defined as follows: T1→[T1.1,T1.2], T1.1→ø,T1.2→ø

### Constraints:

$$Local = T 1. T 1.1 . T 1.2 -> ( a ) starttime + duration = endtime$$

$$Mutual = ( T 1. T 1.1 ) \to \{ \begin{matrix}( b ) T1 .1 . starttime = T 1. starttime . \\ ( c ) T 1.1 . endtime - T 1. starttime + 50 \% T 1. duration\end{matrix} \} . \\ ( T 1. T 1.2 ) -> \{ \begin{matrix}( d ) T 1.2 . starttime = T 1. starttime + 50 \% T 1. duration \\ ( e ) T 1.2 . endtime = T 1. endtime\end{matrix} \}$$

The plan is instantiated as followed (i.e.,^{T}1):
T.1=starttime=0.endtime=2,duration=2
T.1.1:=starttime=0,T1.1.endtime=1,duration=1
T.1.2=starttime=1,endtime=2,duration=1

### Task Extension Example

Changing the ‘endtime’ attribute of a child task to a later time:

```
Apply(modify (T1.2. endtime = 3), T,T1¹)
  Update - down(T 1.2)→
  Begin
  \\update task's parent and local attributes (if desired)
  M ←getMutualInvariants(T1.1,T1.2)\\yielding invariants (d) and (e)
    Begin
      \\notifies parent's task to re-compute its attributes
      Update - up(T1, e)\\only inv (e) is false, notifying parent
      \\recompute task's self attributes
      L ← getLocalInvariants(T1.2)\\yielding invariant (a)
        linv.recompute(T1.2.attributes)
        \\resulting in T1.2: starttime = 1, endtime = 3,duration = 2
      End
\\recursive call to all child nodes
Foreach child ε task.childs →
  Update - down(child)
End
Update - up(T1, e) →
Begin
  inv.recompute(T1. attributes)\\resulting in
  T1: starttime = 0, endtime = 3,duration = 3
  \\check if any of the remaining mutual invariants with any of its children
  are ‘broken’
  \\if yes, rewrite the statement to match the new parent's attributes
  Foreach child ε {T1.1,T1.2) →
      C ← getMutualInvariants(task,child)
      \\yielding invariants (c) and (d) as false
      minv.revise(task, attributes)
      \\revising the coefficient factor in both invariants from 50% to 33%
  \\continue with change propagation to all parents when required
  M → getMutualInvariants (T1.parent,T1)\\none, T1 is the root
      Update - up(task, parent, inv)
End
```

Hence, execution result is (i.e.,new ^{T}^{¹}):
T.1:starttime=0,endtime=3,duration=3
T.1.1::starttime=0,T1.1.endtime=1,duration=1
T.1.2:starttime=1,endtime=3,duration=3
, and also a change to the invariants in the plan ^{T} as follows:

$$Mutual = ( T 1 , T 1.1 ) \to \{ \begin{matrix}( b ) T 1.1 . starttime = T 1. starttime , \\ ( c ) T 1.1 . endtime = T 1. starttime + 33 \% T 1. duration\end{matrix} \} , \\ ( T 1 , T 1.2 ) \to \{ \begin{matrix}( d ) T 1.2 . starttime - T 1. starttime + 33 \% T 1. duration , \\ ( e ) T 1.2 . endtime = T 1. endtime\end{matrix} \}$$

The above described method comprises at least two major operations: rewrite and re-compute. A set of attributes is received as an input indicating the variables to be considered as constrained by their current values within the context of the corresponding invariant expression. The former operation described above is used to rewrite the invariant's own expression, i.e., coefficient parameters, when all of its variables are bound. The latter operation is used to re-compute all free variables within the corresponding expression, considering the expression itself as fixed.

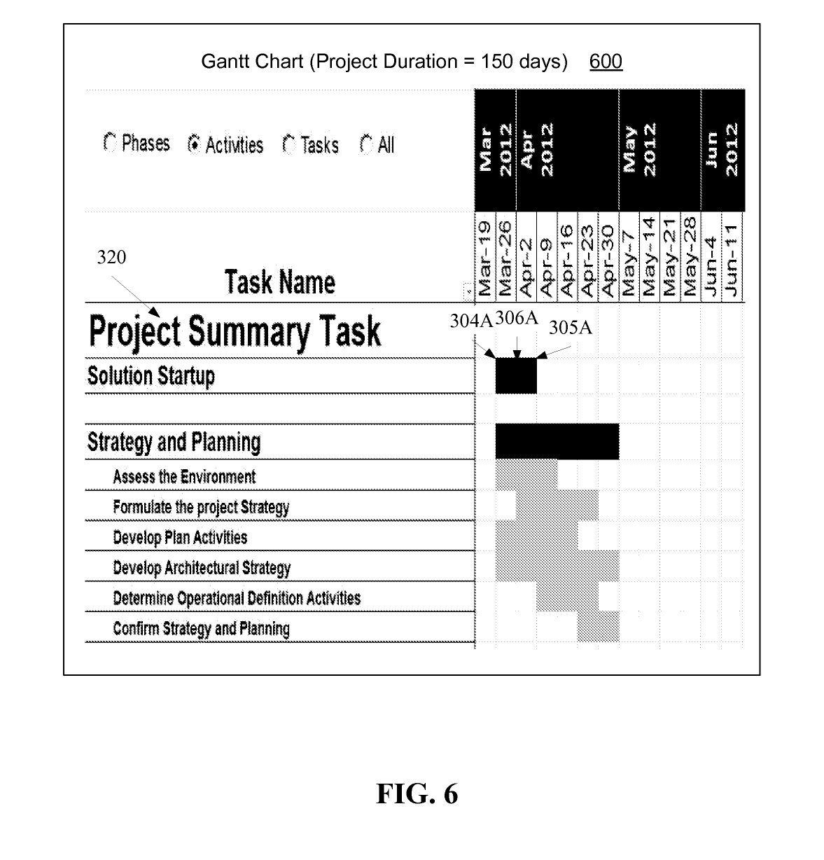

Reference is now made to FIG. 6 illustrating a fragment of a modified project plan Gantt chart 600, according to some embodiments of the present invention. The Gantt chart is as illustrated in FIG. 5, except the project duration is set to 150 days instead of 300 days. Upon update of the “Project Summary Task” tasks' 320 duration to 150 days, the start date 304A, the end date 305A and the duration 306A of the children tasks are updated. In this example, the start date of the “Solution Startup” task 304A is unchanged, while the end date 305A is set to March 8^{th} instead of March 26^{th}.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant project planning methodologies will be developed and the scope of the terms project task and project task characteristics and are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computerized method for project planning, comprising:
receiving a project plan having a plurality of project tasks hierarchically arranged in a plurality of tiers forming a plurality of parent-child relationships and associated by a plurality of constraining rules defined between members of two or more of said plurality of project tasks;
receiving an alteration to at least one altered project task characteristic of a plurality of project task characteristics of an altered project task;
adapting at least one child project task characteristic of a child project task according to said at least one altered project task characteristic in compliance with at least one a plurality of constraining rules defined between said altered project task and said child project task; and
adapting at least one parent project task characteristic of a parent project task according to said at least one altered project task characteristic in compliance with at least one a plurality of constraining rules defined between said altered project task and said parent project task;
wherein said child project task is a child of said altered project task and said parent project task is a parent of said altered project task.

2. The method of claim 1, wherein
said child project task is at least one of a direct child and an indirect child of said altered project task; and
said parent project task is at least one of a direct parent and an indirect parent of altered project task.

3. The method of claim 1, wherein said adapting occurs prior to receiving a request from a user to do at least one of display, read, copy, modify and delete said at least one of a plurality of project task characteristics of a second project task.

4. The method of claim 1, further comprising:
indicating a change of at least one of said child project task and said parent project task.

5. The method of claim 1, wherein said plurality of project task characteristics is scheduling data, provided as at least one of a start date, an end date, a duration period, an amount of working hours, an amount of working days and a relative part of a duration period.

6. The method of claim 1, wherein said plurality of project task characteristics comprises at least one of a budget amount, a relative part of a budget, facility usage and resource consumption.

7. The method of claim 1, wherein said altering is performed by at least one of modifying said plurality of a first at least one of a plurality of project task characteristics and adding an additional at least one of a plurality of project task characteristics.

8. The method of claim 1, further comprising:
receiving an additional plurality of project tasks having an additional plurality of project task characteristics;
associating said additional plurality of project tasks to at least one of said plurality of project tasks by establishing at least one parent-child relationship;
adapting at least one of said plurality of project task characteristics according to said additional plurality of project task characteristics.

9. The method of claim 1, wherein each said plurality of project tasks is at least one of an integrating a software, integrating an instrument, producing a part, designing a part, up-scale a pipeline, quality assurance testing and a project planning task.

10. The method of claim 1, wherein said adapting is automatically performed.

11. The method of claim 10, wherein at least one of said plurality of constraining rules is applicable to two or more tasks to be selected from a group comprising of a percentile, a portion, a multiplication factor, an equality, a range of a plurality of percentiles, a range of a plurality of portions and a range of a plurality of multiplication factors.

12. The method of claim 1, wherein said adapting is performed independently of a user's usage of said plurality of project tasks.

13. The method of claim 1, wherein said plurality of project task characteristics is governed by at least one mutual constraining rule.

14. The method of claim 1, wherein said plurality of project task characteristics is governed by at least one absolute term.

15. The method of claim 14, wherein said at least one absolute term is at least one of a maximal numerical limit, a minimal numerical limit, a maximal date and a minimal date.

16. The method of claim 1, wherein said plurality of tiers is provided by a tree structure.

17. The method of claim 1, wherein said plurality of project tasks relate to one another by at least one of a predecessor relationship, a successor relationship and a parallel occurrence relationship; and wherein said adapting is performed according to a plurality of relations between said plurality of project tasks.

18. The method of claim 1, further comprising: defining a plurality of adaptation strategies.

19. The method of claim 18, wherein each of said plurality of adaptation strategies is at least one of: show inconsistency, resolve inconsistency, and propagate over a subset of said plurality of tiers.

20. A computerized method for project planning, comprising:
a computer readable storage medium;
first program instructions to receive a project plan having a plurality of project tasks hierarchically arranged in a plurality of tiers, associated by a plurality of parent-child relationships;
second program instructions to provide a plurality of project task constraining rules for at least one of said plurality of project tasks;
third program instructions to receive an alteration to a first at least one of a plurality of project task characteristics of a first project task; and
fourth program instructions to adapt a second at least one of a plurality of project task characteristics of a second project task wherein a tier of said second project task is lower in a hierarchy arrangement with respect to a tier of first project task;
wherein said first, second, third and fourth program instructions are stored on said computer readable storage medium.

21. A system for project planning comprising:
a processor;
a graphical user interface which:
receives a project plan having a plurality of project tasks hierarchically arranged in a plurality of tiers, associated by a plurality of parent-child relationships;
enables a user to provide a plurality of project task characteristics for at least one of said plurality of project tasks;
enables a user to alter a first at least one of a plurality of project task characteristics of a first project task; and
a propagation software engine for adapting a second at least one of a plurality of project task characteristics of a second project task wherein a tier of said second project task is lower in a hierarchy arrangement with respect to a tier of first project task, using said processor.
